(19) United States
(12) Patent Application Publication
(10) Pub. No.: US 2026/0017511 A1
(43) Pub. Date: Jan. 15, 2026

(54) TRANSFORMER MODELS FOR IDENTIFICATION OF TOP-K ATTENTION VALUES INFLUENCING OUTPUTS OF OTHER TRANSFORMER MODELS

(71) Applicant: Capital One Services, LLC, McLean, VA (US)

(72) Inventors: Samuel SHARPE, Cambridge, MA (US); Brian BARR, Schenectady, NY (US)

(73) Assignee: Capital One Services, LLC, McLean, VA (US)

(21) Appl. No.: 18/773,510

(22) Filed: Jul. 15, 2024

(51) Int. Cl. G06N 3/08; G06N 3/045

(52) U.S. Cl. CPC G06N 3/08; G06N 3/045

(57) ABSTRACT

Methods and systems are described herein for updating a transformer model to identify key events. In some embodiments, a request to authorize a user may be received including a sequence of events representing interactions of the user with a server. The sequence of events can be provided to a first artificial intelligence model, trained for a particular use case, to obtain a classification result indicating whether the request should be granted. In addition to being provided to the first artificial intelligence model, the sequence of events may be provided to a second artificial intelligence model trained to identify a subset of events from the sequence of events that most heavily contribute to the prediction by the first artificial intelligence model of the classification result.

### BACKGROUND

Transformer models are often used to make predictions. While transformer models are very good at this, it is difficult to provide explanations as to why a transformer model makes a particular prediction. This technical limitation presents a problem when attempting to improve the transformer models to make more accurate predictions as well as establish trust in the predictions being made.

### SUMMARY

Methods and systems are described herein for identifying events that most heavily contribute to a prediction made by a transformer model. In particular, the techniques described herein train a transformer model to learn which events are most important to predictions made by another, separate, transformer model. These technical solutions enable increased understanding of why a transformer model makes a particular prediction, more accurate transformer model predictions, and increased trust in the predictions made by the transformer model.

The disclosed embodiments describe a process for training and implementing an artificial intelligence model, referred to as an explainer model, to identify which inputs influence a prediction made by another artificial intelligence model, referred to as a use-case model. More particularly, the explainer model can identify the most important inputs without needing to access the use-case model's weights, biases, or other settings. During production, the same data input into the use-case model can be input into the trained explainer model. This allows a response to be generated that not only includes the prediction but also an explanation of the prediction. While an attention matrix from the use-case model could provide similar insight, this information is rarely available for end-user consumption. Even when available, knowledge of how to interpret the attention matrix and identify the most important inputs is not readily accessible and requires additional steps to be performed.

To train the explainer model, a sequence of events may be input into the use-case model, which may be a pre-trained model, and the explainer model. In some cases, the explainer model may be initialized with one or more parameter values of the use-case model. The use-case model may be configured to generate a reference authentication score based on the sequence of events. The reference authentication score indicates a likelihood that a request to authorize access to a user associated with the sequence of events will be granted. In some examples, the reference authentication score may be further input into a classifier to generate a classification result indicating whether the request was granted or denied.

In addition to the use-case model, the sequence of events may be input into the explainer model. The explainer model may be configured to generate masking scores for the sequences of events. Each masking score indicates a probability/likelihood that a corresponding event from the sequence of events should be masked. The explainer model's parameters (e.g., weights and biases of layers of a transformer model) can then be tuned to identify events to be masked such that, when the masked sequence of events is input into the use-case model, a prediction is as different as possible from the prediction made from the original (unmasked) sequence of events.

In some embodiments, a threshold function may be applied to the masking scores to convert each masking score to a masking result to form an event mask. The event mask may include the masking results for each event. For example, the event mask may comprise a sequence of binary values each indicating whether the corresponding event is to be masked. Using the event mask, masked event data may be generated including the sequence of events with one or more events masked. The masked event data may be input into the explainer model to obtain a training authentication score. A loss can be computed based on the reference authentication score and the training authentication score. Updates to parameters of the explainer model can be made based on the computed loss, and these steps can be repeated until a threshold training condition is satisfied.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for generating a response to a request including a classification result computed using a first artificial intelligence model and a subset of events most heavily contributing to the classification result, determined using a second artificial intelligence model, in accordance with one or more embodiments.

FIG. 2 shows an example of training data used for training one or more artificial intelligence models, in accordance with one or more embodiments.

FIG. 3 shows an illustrative process for training an artificial intelligence model to output a classification result for responding to a request to authorize access to a user based on a sequence of events associated with the user, in accordance with one or more embodiments.

FIG. 4 shows an illustrative process for training an artificial intelligence model to output a subset of events that most heavily contribute to a prediction made by a separate artificial intelligence model, in accordance with one or more embodiments.

FIG. 5 illustrates an example system for developing and implementing an artificial intelligence model to identify a subset of events from a sequence of events that most heavily contribute to a prediction made by a separate artificial intelligence model, in accordance with one or more embodiments.

FIG. 6 illustrates a flowchart of an example process for generating a response to a request to authorize a user including a classification result determined using a first artificial intelligence model and an indication of a subset of events that most heavily contribute to the classification result determined using a second artificial intelligence model, in accordance with one or more embodiments.

FIG. 7 illustrates a flowchart of an example process for training a first artificial intelligence model to be used as a use-case model for predicting whether to authorize access for a user based on an input sequence of events, in accordance with one or more embodiments.

FIG. 8 illustrates a flowchart of an example process for training a second artificial intelligence model to be used as an explainer model for identifying a subset of events that are most influential to the prediction made by a use-case model, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

While the foregoing description primarily relates to transformer models, persons of ordinary skill in the art will recognize that other artificial intelligence models may be used instead of or in addition to a transformer model. For example, recurrent neural networks (RNNs), temporal convolutional networks (TCNs), graph neural networks (GNNs), or other artificial intelligence models, or combinations thereof, can be trained to generate embeddings and make predictions based on the generated embeddings. Furthermore, descriptions relating to a single artificial intelligence model should not be construed to mean that only one model is used, and some examples may utilize an ensemble model formed of two or more models working together to develop predictions and perform other tasks (e.g., classifications).

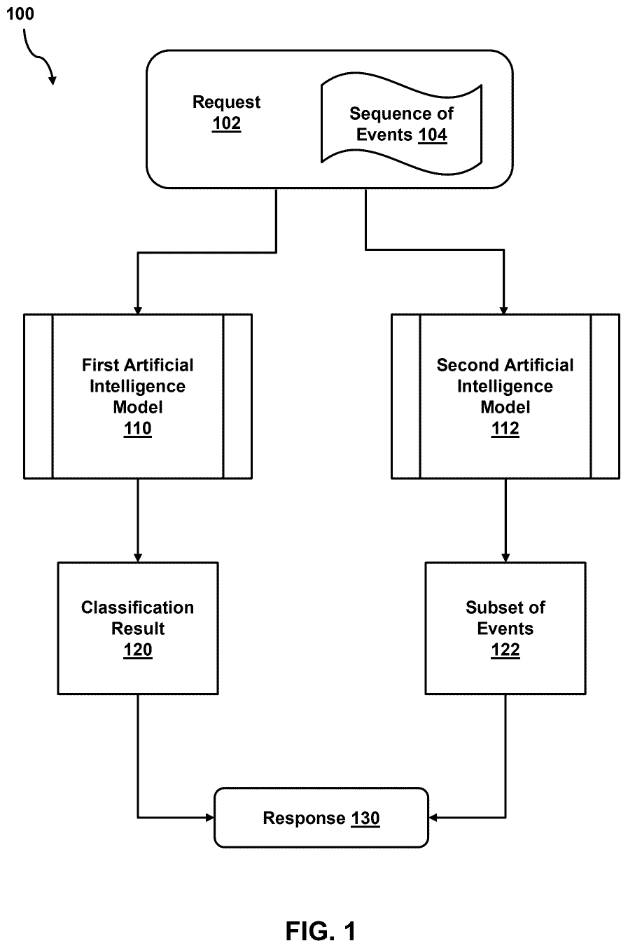

FIG. 1 shows an illustrative system 100 for generating a response to a request including a classification result computed using a first artificial intelligence model and a subset of events most heavily contributing to the classification result, determined using a second artificial intelligence model, in accordance with one or more embodiments. In some embodiments, system 100 may be implemented using one or more computing systems each including memory and processing hardware as well as other components. For example, system 100 may be a cloud-based computing system including cloud-based control circuitry to effectuate software programs, including applications, models, and the like, which end users can interface with.

In some embodiments, system 100 may be configured to receive a request 102 to authorize a user. In one or more examples, request 102 comprises a request to grant access to the user. The access may include allowing the user, via a user device associated with the user, to access secure, private, and/or confidential data. For example, request 102 may be to allow a user to access confidential medical information via the user's user device. The access may alternatively include allowing the user, via their user device, to access a service, a resource, and/or a device. For example, request 102 may be to allow a user to access a streaming-data provider. Still further, the access may include access to a reward, object, and the like. For example, request 102 may be to approve a user for a product (e.g., a medical product, a financial product, a travel product, etc.).

In some embodiments, system 100 may be configured to retrieve event sequence data representing a sequence of events 104 associated with the user based on request 102. Each event corresponds to an interaction between that user (i.e., a user device associated with the user, a computing device accessed by the user) and a computing system (e.g., associated with a service provider with whom the user has an account). For example, an event may store information associated with a given interaction, such as a time that the interaction occurred, a duration of the interaction, a type of interaction that occurred, whether any transactions or operations were performed during the interaction or in association with the interaction, and the like. The sequence of events includes a plurality of events each associated with a different time. The order of the sequence is also important. For example, similar to sequences of text, sequences of events provide contextually relevant information and can be used to formulate predictions. Also, similar to sequences of text, the ordering can be important to the predictions that are made. For example, the same three events can influence three different predictions based on the order in which those events occur within the sequence.

In some embodiments, sequence of events 104 may represent a sequence of events associated with a user and can include each event that has been tracked for that user up to and optionally including the request. Therefore, depending on when the event sequence data including sequence of events 104 is retrieved (and thus, when request 102 is made), the number of events included in sequence of events 104 may vary. Furthermore, persons of ordinary skill in the art will recognize that each user can have a different sequence of events, including different quantities of events, different types of events, different orderings of events, and the like.

FIG. 1 includes a first artificial intelligence model 110. First artificial intelligence model 110 may also be referred to as a “use-case model.” This model is trained to make a particular prediction. For example, the prediction may be whether to grant access to secure data, whether to approve of a transaction, and the like. In some embodiments, first artificial intelligence model 110 may be a transformer model. The transformer model, also referred to interchangeably as a “transformer,” can be implemented using an encoder-decoder architecture. The encoder portion of the transformer model may be configured to generate an embedding or other encoded representation of an input sequence of events, and based on the embedding, the decoder portion may be configured to generate/determine a prediction based on the particular use case the model has been trained for.

In one or more examples, first artificial intelligence model 110 may be configured to compute, or facilitate computation of, an authentication score for the user based on the event sequence data including sequence of events 104. In some embodiments, the authentication score may indicate a likelihood that request 102 will be granted based on sequence of events 104. For example, the authentication score may be a value between 0.0 and 1.0, where an authentication score of 0.0 indicates that the request is to be denied and where an authentication score of 1.0 indicates that the request is to be granted. In some embodiments, first artificial intelligence model 110 may include or be in communication with a classifier configured to determine a classification result 120 for request 102 based on the authentication score. For example, first artificial intelligence model 110 may classify sequence of events 104 into a first class (i.e., request 102 is to be granted) or a second class (i.e., request 102 is to be denied) based on the authentication score. In some embodiments, classification result 120 can provide an indication as to whether that sequence of events 104 associated with the user was classified into the first class or the second class.

As mentioned previously, request 102 may be a request to grant access to a user. In this example, classifying sequence of events 104 may include classifying sequence of events 104 into the first class indicating that access has been granted for the user. Alternatively, classifying sequence of events 104 may include classifying sequence of events 104 into the second class indicating that access was denied for the user.

In some embodiments, generating classification result 120 comprises generating, using first artificial intelligence model 110, based on sequence of events 104, an embedding representing the sequence of events. The embedding refers to a compressed representation of the sequence of events in a computer-understandable format. The embedding may project the sequence of events into an n-dimensional embedding space. In some examples, the embedding may be represented as a vector. In one or more examples, one or more embedding layers of first artificial intelligence model 110 may be trained to generate the embedding. This may include tokenizing each event from the sequence of events, generating a representation of each event token, and computing the embedding based on each event token's representation.

In some embodiments, an authentication score representing a likelihood that the request is to be granted or denied may be generated using first artificial intelligence model 110 based on the embedding. For example, the embedding may be compared to embeddings produced from other sequences of events to identify similarities and classification results associated with those similar sequences. Using those similarities, other classification results may be derived for the given sequence of events.

In some embodiments, first artificial intelligence model 110 is a transformer model having an encoder-decoder architecture. The encoder may be used to generate the embedding and the authentication score, and the decoder may be used to classify the authentication score to obtain the classification result (e.g., the first class or the second class).

In some embodiments, providing access to secure data may be provided to the user (i.e., a user device operated by the user) based on classification result 120 indicating that the event sequence data was classified into the first class. For example, based on sequence of events 104, classification result 120 may indicate that the user should be allowed to access secure data and, subsequent to determining that request 102 to access the secure data was granted, the secure data may be provided to a user device of the user. Providing the secure data may include streamlining data to a user device of the user, sending a hyperlink to a user device of the user to access the secure data, or another mechanism to allow the secure data to be accessed.

In some examples, classifying the authentication score into the first class or the second class comprises determining whether the authentication score is greater than or equal to a threshold data access score. If it is determined that the authentication score is greater than or equal to a threshold data access score, then the event sequence data may be classified into the first class. However, if it is determined that the authentication score is less than the threshold data access score, then the event sequence data may be classified into the second class.

FIG. 1 also includes a second artificial intelligence model 112. Second artificial intelligence model 112 may also be referred to as an “explainer model.” This model is trained to identify events within a sequence of events that have the greatest influence on a prediction made by a use-case model, such as first artificial intelligence model 110. In some embodiments, second artificial intelligence model 112 may also be a transformer model. This transformer model, which can also be referred to interchangeably as a “transformer,” can also be implemented using an encoder-decoder architecture. The encoder portion of the transformer model may be configured to generate an embedding or other encoded representation of an input sequence of events, and based on the embedding, the decoder portion may be configured to generate a masking score indicating a likelihood that masking a given event would degrade the prediction made by the use-case model. In other words, by learning to generate an event mask that causes the use-case model to produce as bad a prediction as possible, the explainer model learns to identify which events are the most important to the use-case model's predictions.

In some embodiments, system 100 may be configured to determine, using second artificial intelligence model 112, a subset of events 122 from sequence of events 104 from request 102. Each event from subset of events 122 may have a masking score that satisfies a threshold masking condition. The masking score can indicate an amount of influence an event has on classification results generated by first artificial intelligence model 110.

In some embodiments, the threshold masking condition being satisfied comprises the masking score of an event being greater than or equal to a threshold masking score. For example, the threshold masking score may be a score that is greater than or equal to 0.75, that is greater than or equal to 0.85, that is greater than or equal to 0.95, or another score. Alternatively, or additionally, the threshold masking condition being satisfied comprises the masking score of an event being one of a top-K masking scores a plurality of masking scores produced by second artificial intelligence model 112 based on the sequence of events represented by sequence of events 104. In this example, the top-K masking scores may refer to a top 25% of the masking scores, a top 10% of the masking scores, a top 5% of the masking scores, and the like. In some embodiments, the particular value of K may be pre-selected. The value of K may also be adjusted. In some embodiments, the value of K may be determined during training.

In some embodiments, the subset of events can indicate which events are the most “important” to the prediction made by first artificial intelligence model 110 when first artificial intelligence model 110 also uses the same input sequence (e.g., the sequence of events represented by sequence of events 104 of request 102). Second artificial intelligence model 112, during training, learns to identify the events that most heavily contribute to the results of first artificial intelligence model 110 but without requiring access to the settings or parameters of first artificial intelligence model 110. This process therefore enables individuals to train an explainer model that learns to identify the most important inputs used by a vast collection of artificial intelligence models to make their predictions. These artificial intelligence models (e.g., use-case models) may be third-party models whose parameter values may not be publicly (or privately) available. By learning to explain why a particular model makes the predictions it makes, improved model transparency for end users can be obtained when using artificial intelligence models to form predictions. For instance, the user can find out, in real time, not only the prediction but the explanation of why that prediction was made.

In some embodiments, system 100 may also be configured to provide, to the user, a response 130 to request 102. Response 130, for example, may include classification result 120 produced by first artificial intelligence model 110 as well as subset of events 122 (or an indication of subset of events 122) from second artificial intelligence model 112. In some embodiments, if classification result 120 indicates that request 102 was granted, response 130 may include a mechanism for accessing secure data (i.e., a user device operated by the user). Providing the secure data may include streamlining data to a user device of the user, sending a hyperlink to a user device of the user to access the secure data, or another mechanism to allow the secure data to be accessed. As an example, response 130 may include a hyperlink to access classification result 120 and subset of events 122. As another example, response 130 may include interface instructions for causing a user interface to be rendered on the user's user device where the user interface presents classification result 120 and subset of events 122 to the user.

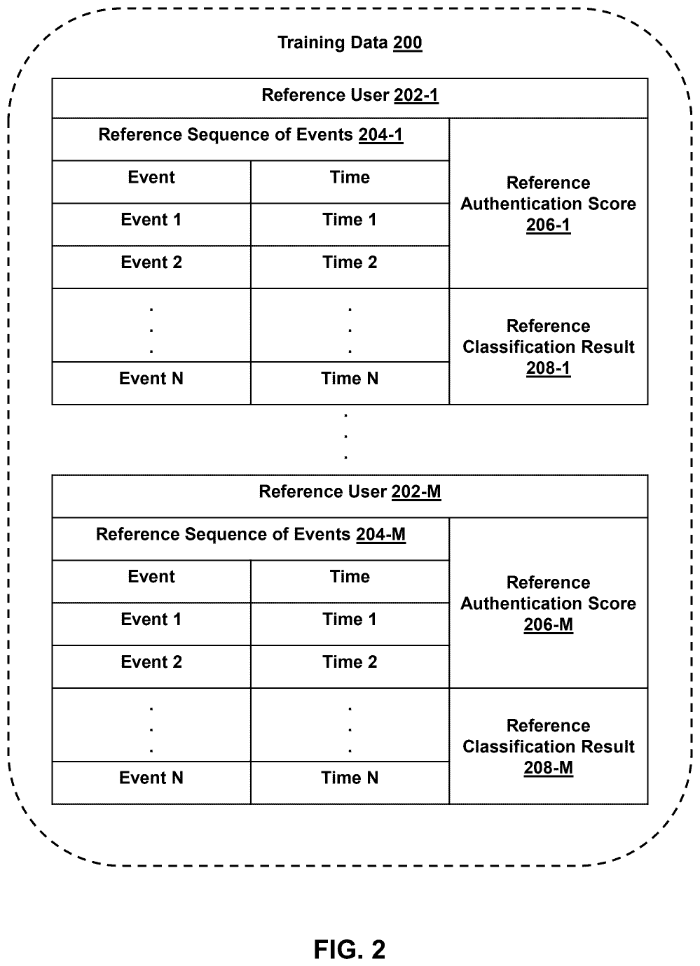

FIG. 2 shows an example of training data 200 used for training one or more artificial intelligence models, in accordance with one or more embodiments. Training data 200 is meant to be illustrative. For example, training data 200 may also include validation data and testing data. For example, of a plurality of reference sequences of events, three sets may be created: a training set, a testing set, and a validation set. The reference sequence events may be split using any appropriate training/testing/validation split (e.g., 80/10/10, 85/5/10, etc.). Thus, for simplicity, training data 200 is representative of a training set, a testing set, and/or a validation set.

In some embodiments, training data 200 may include training event sequence data associated with a plurality of reference users, such as reference users 202-1 through 202-M (collectively “reference users 202”), each including reference sequences of events 204-1 through 204-M (collectively “reference sequences of events 204”). In some examples, reference sequences of events 204 may be derived from sequences of events of real users. In some examples, the training event sequence data included in training data 200 may be synthetic training data. For example, using one or more generative artificial intelligence models, synthetic event sequence data may be generated and used as reference sequences of events 204.

The training event sequence data for each of reference users 202 may also include reference authentication scores and reference classification results. For example, training data 200 may include reference authentication scores 206-1 through 206-M (collectively “reference authentication scores 206”) and reference classification results 208-1 through 208-M (collectively “reference classification results 208”). Each of reference authentication scores 206 may refer to a ground truth authentication score generated based on a corresponding reference sequence of events (e.g., reference authentication score 206-1 corresponds to reference sequence of events 204-1). Each of reference classification results 208 may refer to a ground truth classification score generated based on the corresponding reference authentication score 206. For example, reference classification result 208-1 may correspond to reference sequence of events 204-1.

In some embodiments, each of reference sequences of events 204 may include N events occurring at N different times. For simplicity, each of reference sequences of events 204 includes a same quantity of events; however, some sequences may include fewer or more events. In some embodiments, sequences of events having less than a threshold number of events may be padded with null values to cause each reference sequence of events to be the same length.

In some embodiments, a given sequence of events may occur at various times T1-TN. The amount of time between the events may be the same or may vary. In some embodiments, the relative timing between events may be computed and used to help compute reference authentication scores 206 and/or reference classification results 208.

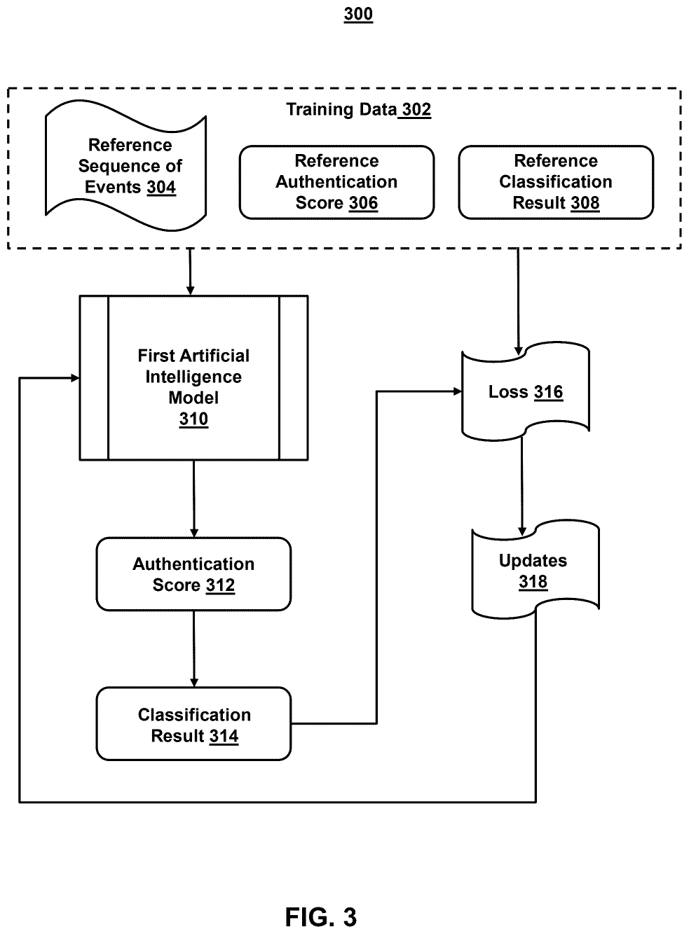

FIG. 3 shows an illustrative process 300 for training an artificial intelligence model to output a classification result for responding to a request to authorize access to a user based on a sequence of events associated with the user, in accordance with one or more embodiments. In some embodiments, first artificial intelligence model 310 may be trained using process 300 to obtain first artificial intelligence model 110. First artificial intelligence model 310, therefore, may be trained prior to being used to analyze production data, as detailed with respect to FIG. 1. In some examples, first artificial intelligence model 310 may be a pre-trained model. In this scenario, process 300 may be omitted or may be used as a “fine-tuning” step for training a model to respond to task-specific data (i.e., production data). The foregoing description related to training first artificial intelligence model 310, therefore, is exemplary.

In some embodiments, training first artificial intelligence model 310 may include accessing training data 302 to be used to train first artificial intelligence model 310. Training data 302 may include (a) training event sequence data comprising a plurality of reference sequences of events, (b) a plurality of reference authentication scores respectively associated with the plurality of reference sequences of events, and (c) a plurality of reference classification results respectively associated with the plurality of reference authentication scores. The reference sequences of events may be associated with a plurality of reference users. The reference classification results, for example, may provide an indication of a class that the input reference event sequence data has been classified into as a result of a current iteration of the training process.

As an example, training data 302 may include a first reference sequence of events associated with a first reference user and a second reference sequence of events associated with a second reference user. With reference to FIG. 2, for example, the first reference sequence of events may refer to reference sequence of events 204-1 corresponding to reference user 202-1 and may have reference authentication score 206-1 and reference classification result 208-1, while the second reference sequence of events may refer to reference sequence of events 204-M corresponding to M-th reference user 202-M and may have reference authentication score 206-M and reference classification result 208-M.

In some examples, to obtain the reference classification results, the reference authentication scores may be compared to a threshold authentication score. The threshold authentication score may correspond to a threshold data access score, which indicates whether a request should be granted based on a given reference sequence of events input into first artificial intelligence model 310. In one or more examples, the reference classification results may comprise a first value indicating that the reference event sequence data has been classified into a first class indicating that the reference authentication score is greater than or equal to the threshold authentication score. In one or more examples, the reference classification results may comprise a second value indicating that the reference event sequence data has been classified into a second class indicating that the reference authentication score is less than the threshold authentication score.

In some embodiments, training first artificial intelligence model 310 includes selecting a reference sequence of events 304 from the plurality of reference sequences of events of the training event sequence data. In some cases, selecting reference sequence of events 304 may also include selecting reference authentication score 306 and reference classification result 308, each associated with reference sequence of events 304. In some embodiments, reference authentication score 306 and reference classification result 308 may be determined prior to first artificial intelligence model 310 being trained. In some embodiments, training process 300 may proceed for reference sequence of events 304, reference authentication score 306, and reference classification result 308 for one reference user (e.g., reference user 202-1), and subsequent to completion, another sequence of events, reference authentication score, and reference classification result may be selected and the training repeated. Alternatively, multiple sequences of events, reference authentication scores, and reference classification results may be selected together.

The reference sequence of events may be input into the first artificial intelligence model to obtain a training authentication score for the reference user. For example, reference sequence of events 304 may be input into first artificial intelligence model 310. First artificial intelligence model 310 may be configured to output an authentication score 312. The training authentication score, authentication score 312, may indicate a likelihood that a request to grant access to a reference user associated with reference sequence of events 304 will be granted based on reference sequence of events 304.

In some embodiments, a classification result 314 may be determined based on authentication score 312 and a threshold data access score, as mentioned above. If authentication score 312 is determined to be less than the threshold authentication score, then classification result 314 may comprise a first value indicating that reference sequence of events 304 has been classified into a first class indicating that authentication score 312 is greater than or equal to the threshold authentication score. Alternatively, classification result 314 may comprise a second value indicating that reference sequence of events 304 has been classified into a second class indicating that authentication score 312 is less than the threshold authentication score.

In some embodiments, a loss 316 may be computed based on the training authentication score (e.g., authentication score 312) and reference authentication score 306 associated with reference sequence of events 304. In some examples, loss 316 may be computed based on classification result 314 and reference classification result 308. Loss 316 represents how accurate first artificial intelligence model 310 is for a given sequence of events. The larger the loss, generally, the more the model's outputs differ from the ground truth. Therefore, training process 300 may include an optimization step, which may leverage one or more optimization algorithms (e.g., stochastic gradient descent, Adam optimizer, etc.) to minimize loss 316. In some embodiments, training process 300 may attempt to minimize loss 316 by determining updates 318 to first artificial intelligence model 310. Updating parameters of first artificial intelligence model 310 may include adjusting weights, biases, or other settings of first artificial intelligence model 310 so as to reduce loss 316, as well as losses computed during the next stages of training process 300.

In some embodiments, the aforementioned training process 300 for training first artificial intelligence model 310 may further include a step of determining whether a threshold training condition has been satisfied. The threshold training condition being satisfied may comprise a threshold number of reference sequences of events being analyzed, an accuracy of the first artificial intelligence model being greater than or equal to a threshold model accuracy score (e.g., 80% accurate, 90% accurate, etc.), a threshold amount of time elapsing, or other criteria being met. If it has been determined that the threshold training condition has not been satisfied, training process 300 may repeat for another reference sequence of events of the plurality of reference sequences of events associated with another reference user. For example, if reference sequence of events 304 corresponded to reference sequence of events 204-1 of reference user 202-1, then in response to determining that the threshold training condition has not been satisfied, another reference sequence of events, such as reference sequence of events 204-M of reference user 202-M, may be selected. This process may iterate until the threshold training condition has been satisfied.

However, if there has been a determination that the threshold training condition has been satisfied, then first artificial intelligence model 310 may be stored and/or deployed for analysis of production data. For example, first artificial intelligence model 310, after training has completed, may be deployed as first artificial intelligence model 110 used to analyze production data (e.g., requests, such as request 102).

In one or more embodiments, upon determining that the threshold training condition has been satisfied, one or more parameter values of the one or more parameters of first artificial intelligence model 310 may be provided to a second artificial intelligence model (e.g., second artificial intelligence model 112, prior to training, as detailed below). These parameter values can be used as one or more initial parameter values for one or more parameters of the second artificial intelligence model during training. Alternatively, some or all of the parameters of the second artificial intelligence model may have their values initialized prior to training and may not leverage the parameter values determined during training process 300.

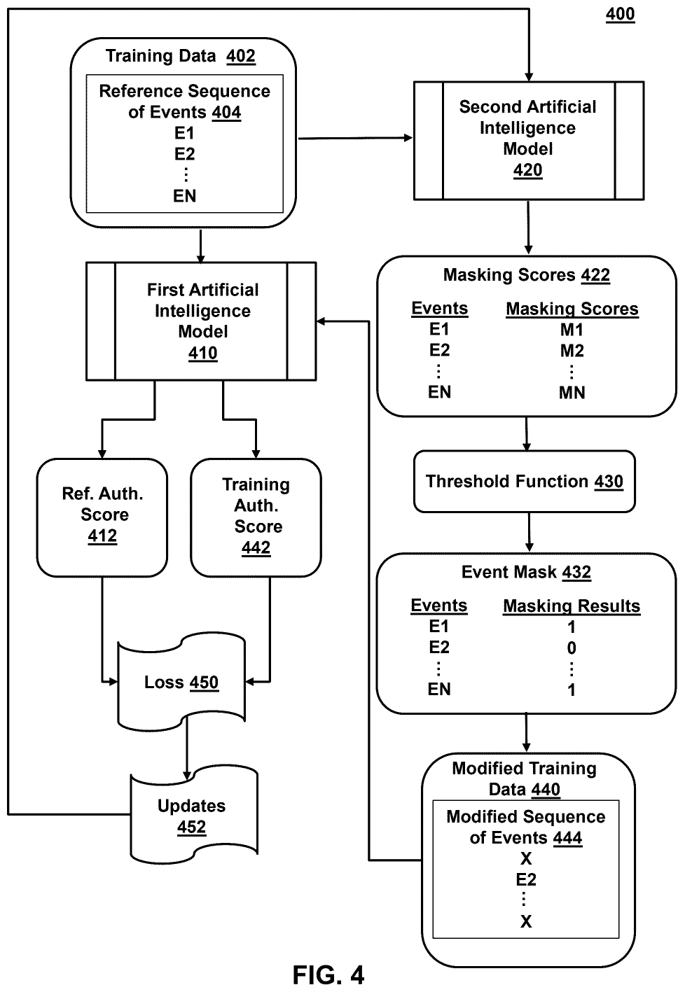

FIG. 4 shows an illustrative process 400 for training an artificial intelligence model to output a subset of events that most heavily contribute to a prediction made by a separate artificial intelligence model, in accordance with one or more embodiments. In some embodiments, second artificial intelligence model 420 may be trained using process 400 to obtain second artificial intelligence model 112. Therefore, second artificial intelligence model 420 may be trained prior to being used to analyze production data, as detailed with respect to FIG. 1.

In training process 400, first artificial intelligence model 410 may refer to first artificial intelligence model 110 of FIG. 1. Therefore, first artificial intelligence model 410 may be configured to receive training event data including a reference sequence of events of a reference user and output a training authentication score. The training authentication score may indicate a predicted likelihood that a request would be granted for providing access (e.g., to secure/confidential data) based on the reference sequence of events. In some embodiments, second artificial intelligence model 420 may be trained by initializing at least one of its parameters with a corresponding value of at least one parameter from the first artificial intelligence model (e.g., first artificial intelligence model 110 or 410). In other words, some or all of the parameters of the first artificial intelligence model (e.g., first artificial intelligence model 110 or 410) may be used as initialized values for parameters of the second artificial intelligence model (e.g., second artificial intelligence model 112 or 420).

In some embodiments, first artificial intelligence model 410 and second artificial intelligence model 420 can be discriminative models. The process of training second artificial intelligence model 420 can leverage the outputs from first artificial intelligence model 410 to learn how to improve its predictive abilities. In the example of training process 400, the same training data may be input into both models; however, only one of those models has unfixed parameters (e.g., second artificial intelligence model 420).

In some embodiments, second artificial intelligence model 420 may also be trained using training data 402. Training data 402 may be the same or similar to the training event sequence data used to train first artificial intelligence model 310 of FIG. 3. For example, training data 402 used to train second artificial intelligence model 420 may also include the plurality of reference sequences of events E1-EN. These reference sequences of events may have a similar structure and/or include similar information as reference sequence of events 304 used to train first artificial intelligence model 310 of FIG. 3. However, reference sequence of events 304 used to train first artificial intelligence model 310 (thereby obtaining first artificial intelligence model 410) may differ from those used to train second artificial intelligence model 420.

In some embodiments, training second artificial intelligence model 420 may include selecting a reference sequence of events 404 from the plurality of reference sequences of events of training data 402. Reference sequence of events 404 may be associated with a reference user. The reference user may be one of a plurality of reference users associated with the plurality of reference sequences of events. As an example, reference sequence of events 404 may correspond to any of reference sequences of events 204 associated with reference users 202 of FIG. 2. In some embodiments, reference sequence of events 404 of training data 402 may be the same or similar to reference sequence of events 304 of training data 302 of FIG. 3, and the previous description may apply.

In some embodiments, reference sequence of events 404 of training data 402 may be input into first artificial intelligence model 410 to obtain a reference authentication score 412. As mentioned previously, first artificial intelligence model 410 may represent a trained instance of first artificial intelligence model 310 of FIG. 3, which has been trained to generate authentication scores indicating a likelihood that a request to authorize access to a reference user associated with a reference sequence of events will be granted. As an example, reference authentication score 412 indicates a likelihood that a request to authorize access for a reference user associated with reference sequence of events 404 from training data 402 will be granted. In some examples, reference authentication score 412 may be a numerical value (e.g., a number between 0-100) or a discrete score (e.g., Tier 1, Tier 2, etc.). In some examples, reference authentication score 412 can be compared to a threshold authentication score to determine a classification result for reference sequence of events 404. For example, the classification result may indicate that reference sequence of events 404 has been classified. In some examples, the first class can indicate that the request to authorize access for the reference user has been granted. As another example, the classification result may indicate that reference sequence of events 404 has been classified into a second class. In some examples, the second class can indicate that the request to authorize access for the reference user has been denied. The process of obtaining classification results associated with the reference authentication scores is described in more detail above with respect to FIG. 3.

In some embodiments, the same reference sequence of events input into the first artificial intelligence model may also be input into the second artificial intelligence model to obtain a plurality of training masking scores. For example, looking again at training process 400, reference sequence of events 404 of training data 402 may be selected and provided to first artificial intelligence model 410 to obtain reference authentication score 412 and to second artificial intelligence model 420 to obtain training masking scores 422. Each training masking score of masking scores 422 indicates a likelihood that a corresponding event from reference sequence of events 404 is to be masked. In particular, second artificial intelligence model 420 is attempting to mask events that contribute the most to the predictions made by first artificial intelligence model 410. Persons of ordinary skill in the art will recognize that the reference sequence of events may be input into the first artificial intelligence model before, after, or substantially in parallel to submission of the reference sequence of events to the second artificial intelligence model. As an illustrative example, if reference sequence of events 404 includes events E1-EN, masking scores 422 may include masking scores M1-MN, which respectively correspond to events E1-EN.

The goal of the masking is to generate a sequence of events that, when input into first artificial intelligence model 410, produces a training authentication score that is maximally different from a reference authentication score produced as a result of an unmasked version of that sequence of events. Thus, second artificial intelligence model 420 learns to produce masks that identify the most important events from a sequence and mask those events. As a result, second artificial intelligence model 420 learns to identify the most important events without requiring parameter values of first artificial intelligence model 410.

In some embodiments, a training event mask 432 comprising a plurality of training event masking results each respectively associated with training masking scores 422 may be generated. Training event mask 432 may be generated based on a threshold function 430 being applied to masking scores 422. Training event masking results included within event mask 432 can indicate that a corresponding event (e.g., events E1-EN) from reference sequence of events 404 is to be masked or is to remain unmasked.

In some embodiments, training event masking results may be a first value or a second value. The first value may indicate that a corresponding training masking score (e.g., masking score M1) of an event (e.g., event E1) from a reference sequence of events (e.g., reference sequence of events 404) satisfies the threshold masking condition. The second value may indicate that a corresponding training masking score (e.g., masking score M2) of an event (e.g., event E2) from the reference sequence of events (e.g., reference sequence of events 404) fails to satisfy the threshold masking condition. In some embodiments, the training event masking results may be binary results. For example, the first value may be a logic “1” indicating that the threshold masking condition has been satisfied for a given masking score (e.g., masking score M1). The second value, in this example, may be a logical “0” indicating that the training masking score fails to satisfy the threshold masking condition (e.g., masking score M2).

In some embodiments, threshold function 430 may be used to generate event mask 432 including masking results indicating which events from reference sequence of events 404 are to be masked. The threshold function 430 may specify one or more threshold masking conditions. For example, threshold function 430 may specify that a threshold masking condition is satisfied if it determined that a corresponding masking score is greater than or equal to a threshold masking score. In some examples, the threshold masking score may be a pre-selected number. For example, if masking scores 422 are numerical values between 0.0 and 1.0, then the threshold masking score specified by threshold function 430 may be a number greater than 0.0 and less than 1.0 (e.g., 0.75 or greater, 0.85 or greater, 0.95 or greater, etc.).

In some embodiments, threshold function 430 may specify other threshold conditions for determining masking results. One other example threshold condition comprises selecting top-K events for masking. In this example, K may be an adjustable parameter. The top-K events may be determined by ranking masking scores 422. After identifying the value to use for K, those events that form the top-K events may be assigned a first value, while the remaining events may be assigned a second value. In some examples, the first value may indicate that a corresponding event from reference sequence of events 404 is to be masked, while the second value may indicate that the corresponding event from reference sequence of events 404 is to remain unmasked. In some examples, a value of K may be determined from training. In some examples, a value of K may be determined from downstream applications. For example, credit decisions may need to provide four (4) or more turndown reasons.

Training event mask 432 may be applied to reference sequence of events 404 to generate a masked training event data 440 representing a modified sequence of events 444. Modified sequence of events 444 may include a same number of events as reference sequence of events 404. However, one or more events from modified sequence of events 444 may be masked. As an illustrative example, while reference sequence of events 404 included events E1, E2, . . . , EN, modified sequence of events 444 includes events X, E2, . . . , X. In this example, X indicates that data associated with a corresponding event in the sequence (e.g., event E1, EN) is to be masked. By masking certain events, a model processing the masked sequence of events has less information to predict from. As a result, the model should produce results that are less accurate than if the data was unmasked. In particular, certain events may contribute more to a model's output. Therefore, if by masking a particular event a worse result is produced, it is more likely that the event was “important” to the model's output.

Modified sequence of events 444 may be input into first artificial intelligence model 410 to obtain a training authentication score 442. Training authentication score 442 represents a likelihood that a request to provide access to a user based on modified sequence of events 444 will be granted. If training authentication score 442 is worse than reference authentication score 412, this indicates that the events masked in modified sequence of events 444 were important to first artificial intelligence model 410's production of reference authentication score 412. Therefore, second artificial intelligence model 420 was able to identify at least some of the most important events from reference sequence of events 404, providing at least a portion of an explanation as to why first artificial intelligence model 410 generates its outputs.

In some embodiments, a loss 450 may be computed using a first training authentication score (e.g., reference authentication score 412) and a second training authentication score (e.g., training authentication score 442). Loss 450 may provide an indication of how well second artificial intelligence model 420 did at identifying the most important events from reference sequence of events 404 to predictions made by first artificial intelligence model 410. Of note is that, in training second artificial intelligence model 420, access to parameters of first artificial intelligence model 410 is not needed. Therefore, training process 400 can be used when first artificial intelligence model 410 is only accessible via an API or other prompting system.

In some embodiments, one or more parameters of second artificial intelligence model 420 may be updated, represented by updates block 452, based on loss 450 computed using first training authentication score (e.g., reference authentication score 412) and second training authentication score (e.g., training authentication score 442). For example, weights, biases, or other parameters of second artificial intelligence model 420 may be adjusted based on loss 450.

Subsequent to updating the parameters of second artificial intelligence model 420, a determination may be made as to whether second artificial intelligence model 420 satisfies a threshold training condition. The threshold condition, in some examples, may indicate that training process 400 for training second artificial intelligence model 420 can stop. In some embodiments, the threshold condition being satisfied comprises a threshold number of reference sequences of events (e.g., reference sequences of events 204) being analyzed, an accuracy of second artificial intelligence model 420 being greater than or equal to a threshold model accuracy score (e.g., 80% accurate, 90% accurate, etc.), a threshold amount of time elapsing, or other criteria being met. If it is determined that second artificial intelligence model 420, subsequent to the parameters of second artificial intelligence model 420 being updated, satisfies the threshold training condition, then second artificial intelligence model 420 may be stored for deployment (i.e., to analyze production data, as seen by second artificial intelligence model 112 of FIG. 1). However, if it is determined that second artificial intelligence model 420, subsequent to the parameters of second artificial intelligence model 420 being updated, fails to satisfy the threshold training condition, the aforementioned training steps may be repeated using another reference sequence of training events. For example, if reference sequence of events 404 corresponds to reference sequence of events 204-1 of FIG. 2, then another reference sequence of events (e.g., another one of reference sequences of events 204) may be selected and used to execute training process 400. Training process 400 may then repeat until the threshold training condition has been satisfied or another stopping condition has been met.

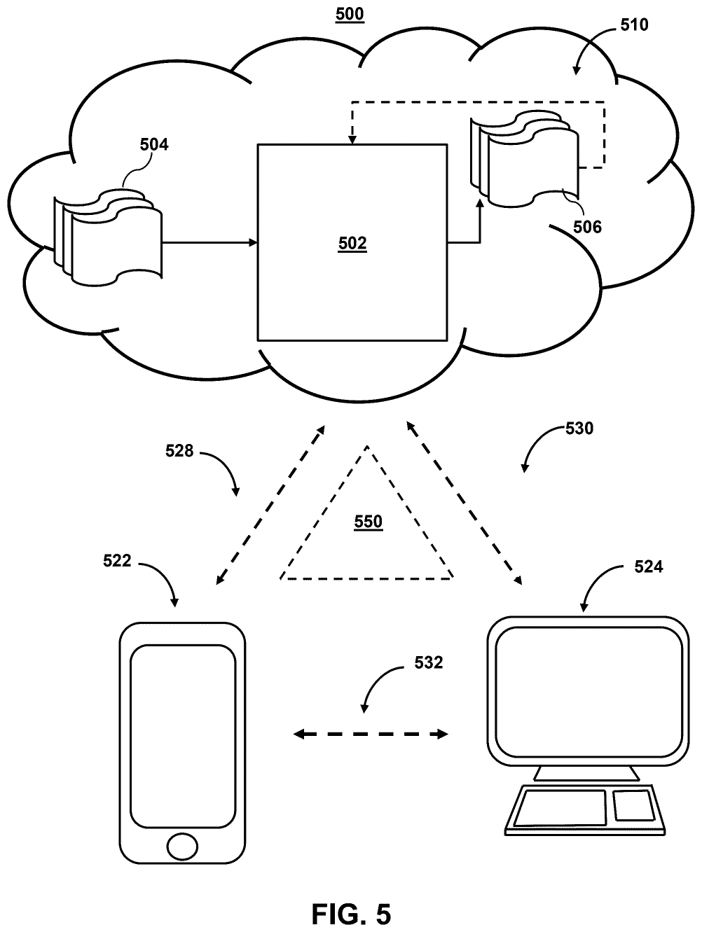

FIG. 5 illustrates an example system 500 for developing and implementing an artificial intelligence model to identify a subset of events from a sequence of events that most heavily contribute to a prediction made by a separate artificial intelligence model, in accordance with one or more embodiments. For example, FIG. 5 may show illustrative components for decomposing attention values into event components and temporal components, which in turn can be used to determine or update transformer model classifications. As shown in FIG. 5, system 500 may include mobile device 522 and user terminal 524. While shown as a smartphone and personal computer, respectively, in FIG. 5, it should be noted that mobile device 522 and user terminal 524 may be any computing device, including, but not limited to, a laptop computer, a tablet computer, a handheld computer, and other computer equipment (e.g., a server), including “smart,” wireless, wearable, and/or mobile devices. FIG. 5 also includes cloud components 510.

Cloud components 510 may alternatively be any computing device as described above and may include any type of mobile terminal, fixed terminal, or other device. For example, cloud components 510 may be implemented as a cloud computing system and may feature one or more component devices. In some embodiments, system 100 of FIG. 1 may be implemented as cloud components 510. It should also be noted that system 500 is not limited to three devices. Users may, for instance, utilize one or more devices to interact with one another, one or more servers, or other components of system 500. It should be noted that, while one or more operations are described herein as being performed by particular components of system 500, these operations may, in some embodiments, be performed by other components of system 500. As an example, while one or more operations are described herein as being performed by components of mobile device 522, these operations may, in some embodiments, be performed by components of cloud components 510. In some embodiments, the various computers and systems described herein may include one or more computing devices that are programmed to perform the described functions. For example, the functionalities described above with respect to system 100 and/or training processes 300 and 400 may be implemented via one or more computing devices programmed to perform the aforementioned functions. Additionally, or alternatively, multiple users may interact with system 500 and/or one or more components of system 500. For example, in one embodiment, a first user and a second user may interact with system 500 using two different components.

With respect to the components of mobile device 522, user terminal 524, and cloud components 510, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 5, both mobile device 522 and user terminal 524 include a display upon which to display data.

Additionally, as mobile device 522 and user terminal 524 are shown as a touchscreen smartphone and a personal computer, these displays also function as user input interfaces. It should be noted that in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 500 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, virtual private networks, and/or other virtual storage resources). The electronic storages may store software algorithms, information determined by the processors, information obtained from servers, information obtained from client devices, or other information that enables the functionality as described herein.

FIG. 5 also includes communication paths 528, 530, and 532. Communication paths 528, 530, and 532 may include the Internet, a mobile phone network, a mobile voice or data network (e.g., a 5G or LTE network), a cable network, a public switched telephone network, or other types of communications networks or combinations of communications networks. Communication paths 528, 530, and 532 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 510 may also include model 502, which may be a machine learning model, artificial intelligence model, etc. (which may be referred to collectively as “models” herein). As an illustrative example, model 502 may represent a transformer model. In some embodiments, model 502 may correspond to first artificial intelligence model 110 and/or second artificial intelligence model 112 of FIG. 1. In some embodiments, model 502 may represent an untrained model or a model being trained (e.g., artificial intelligence models 310, 410, 420); however, persons of ordinary skill in the art will recognize that this is exemplary and model 502 may be a trained artificial intelligence model.

Model 502 may take inputs 504 and provide outputs 506. The inputs may include multiple datasets, such as a training dataset and a test dataset. Each of the plurality of datasets (e.g., inputs 504) may include data subsets related to user data, predicted forecasts and/or errors, and/or actual forecasts and/or errors. In some embodiments, outputs 506 may be fed back to model 502 as input to train model 502 (e.g., alone or in conjunction with user indications of the accuracy of outputs 506, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., consistency of labels, predicted labels, version metadata, etc.).

In some embodiments, where model 502 is or includes a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, model 502 may be trained to generate better predictions.

In some embodiments, model 502 may include an artificial neural network. In such embodiments, model 502 may include an input layer and one or more hidden layers. Each neural unit of model 502 may be connected with many other neural units of model 502. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 502 may be self-learning and trained, rather than explicitly programmed, and can perform significantly better in certain areas of problem solving as compared to traditional computer programs. During training, an output layer of model 502 may correspond to a classification of model 502, and an input known to correspond to that classification may be input into an input layer of model 502 during training. During testing, an input without a known classification may be input into the input layer, and a determined classification may be output.

In some embodiments, model 502 may include multiple layers (e.g., where a signal path traverses from front layers to back layers). In some embodiments, backpropagation techniques may be utilized by model 502 where forward stimulation is used to reset weights on the “front” neural units. In some embodiments, stimulation and inhibition for model 502 may be more free-flowing, with connections interacting in a more chaotic and complex fashion. During testing, an output layer of model 502 may indicate whether or not a given input corresponds to a classification of model 502.

System 500 also includes API layer 550. API layer 550 may allow the system to generate summaries across different devices. In some embodiments, API layer 550 may be implemented on mobile device 522 or user terminal 524. Alternatively, or additionally, API layer 550 may reside on one or more of cloud components 510. API layer 550 (which may be a REST or web services API layer) may provide a decoupled interface to data and/or functionality of one or more applications. API layer 550 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in B2B transactions.

API layer 550 may use various architectural arrangements. For example, system 500 may be partially based on API layer 550, such that there is strong adoption of SOAP and RESTful web services, using resources like Service Repository and Developer Portal, but with low governance, standardization, and separation of concerns. Alternatively, system 500 may be fully based on API layer 550, such that separation of concerns between layers like API layer 550, services, and applications are in place.

In some embodiments, the system architecture may use a microservice approach. Such systems may use two types of layers: front-end layer and back-end layer where microservices reside. In this kind of architecture, the role of API layer 550 may provide integration between front-end and back-end. In such cases, API layer 550 may use RESTful APIs (exposition to front-end or even communication between microservices). API layer 550 may use AMQP (e.g., Kafka, RabbitMQ, etc.). API layer 550 may use incipient usage of new communications protocols such as gRPC, Thrift, etc.

In some embodiments, the system architecture may use an open API approach. In such cases, API layer 550 may use commercial or open-source API platforms and their modules. API layer 550 may use a developer portal. API layer 550 may use strong security constraints applying WAF and DDOS protection, and API layer 550 may use RESTful APIs as standard for external integration.

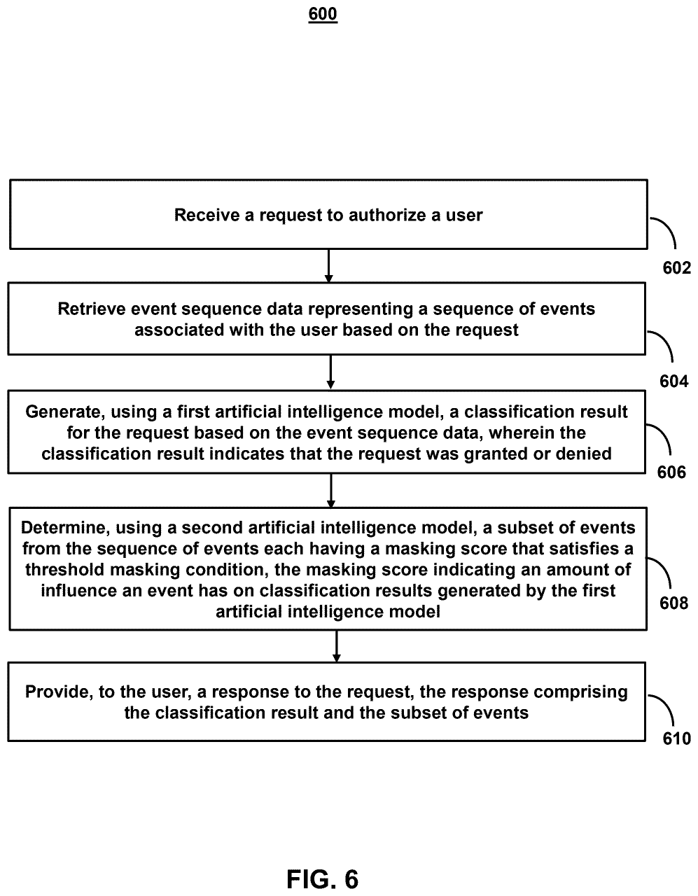

FIGS. 6-8 are illustrative flowcharts associated with implementing and training an artificial intelligence model to identify a subset of events from a sequence of events that most influence predictions of another artificial intelligence model, as well as the implementation and training of the other artificial intelligence model, in accordance with one or more embodiments. Persons of ordinary skill in the art will recognize that steps from any of FIGS. 6-8 may be performed with other steps from FIGS. 6-8. Furthermore, some steps of FIGS. 6-8 may be performed by a single device or by a set of devices (including cloud computing components), such as the components described above with reference to FIG. 5.

FIG. 6 illustrates a flowchart of an example process 600 for generating a response to a request to authorize a user including a classification result determined using a first artificial intelligence model and an indication of a subset of events that most heavily contribute to the classification result determined using a second artificial intelligence model, in accordance with one or more embodiments. In some embodiments, process 600 may begin at step 602. At step 602, a request to authorize a user may be received. For example, request 102 may be received to authorize a user. In one or more examples, the request comprises a request to grant access to the user. The access may include access to secure, private, and/or confidential data. The access may alternatively include access to a service, a resource, and/or a device. Still further, the access may include access to a reward, object, and the like. As an illustrative example, the request may be a request to allow a user device associated with the user to access streaming content. As another example, the request may be a request to approve a transaction associated with an account of the user.

At step 604, event sequence data representing a sequence of events associated with the user may be retrieved based on the request. For example, request 102 may include sequence of events 104. The sequence of events may include events, each representing an interaction of a user with a service provider, server, or other computing system. For example, the sequence of events may represent interactions of a user with a social networking application. The sequence of events may occur at a plurality of times. The times may be evenly separated; however, in some cases, the times may be sporadic. For example, the time between event 1 and event 2 may be a first time difference, and the time between event 2 and event 3 may be a second time difference. In this example, the first time difference and the second time difference may be the same or may differ.

At step 606, a classification result may be generated using a first artificial intelligence model for the request based on the event sequence data. The classification result indicates that the request was granted or denied. For example, first artificial intelligence model 110 may be trained to output classification result 120 indicating that request 102 was granted or denied. In some examples, first artificial intelligence model 110 may be a trained transformer model, such as a large language model (LLM). In some embodiments, first artificial intelligence model 110 may generate an authentication score based on the event sequence data, and the classification result may be determined based on the authentication score.

At step 608, a subset of events from the sequence of events each having a masking score that satisfies a threshold masking condition may be determined using a second artificial intelligence model. The masking score may indicate an amount of influence an event has on classification results generated by the first artificial intelligence model. For example, second artificial intelligence model 112 may identify subset of events 122 as being the events from sequence of events 104 that contributed the most to first artificial intelligence model 110 producing classification result 120. In some examples, subset of events 122 may include events that produced the top-K masking scores.

At step 610, a response to the request may be provided to the user. In some embodiments, the response may include comprising the classification result and the subset of events. For example, response 130 may include classification result 120 and subset of events 122.

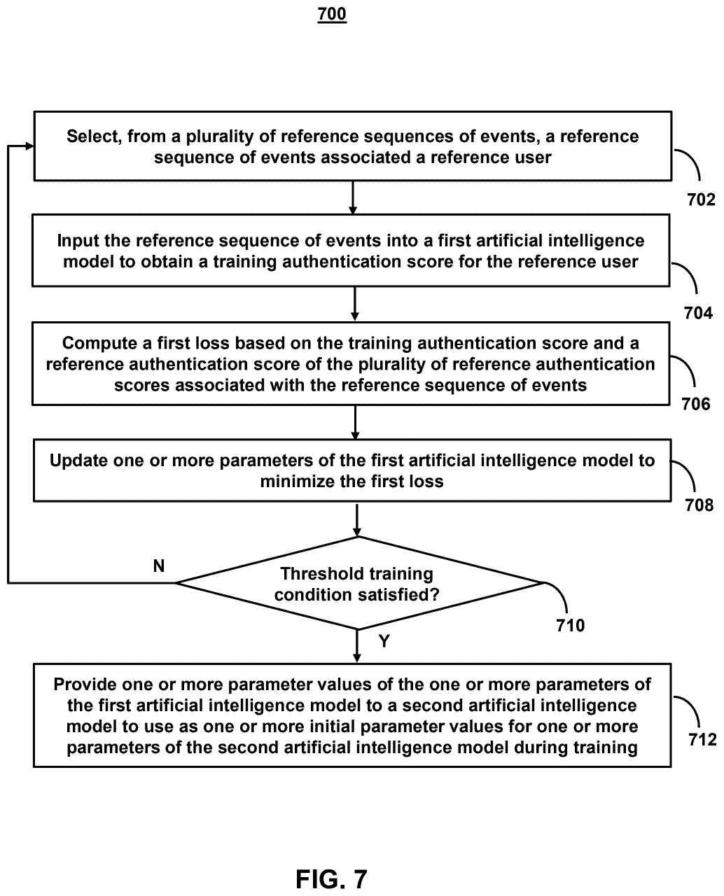

FIG. 7 illustrates a flowchart of an example process 700 for training a first artificial intelligence model to be used as a use-case model for predicting whether to authorize access for a user based on an input sequence of events, in accordance with one or more embodiments. In some embodiments, process 700 may be used to train a model to be used as first artificial intelligence model 110 of FIG. 1. In some embodiments, process 700 may begin at step 702.

At step 702, a reference sequence of events associated with a reference user may be selected from a plurality of reference sequences of events. For example, training data 302 may include reference sequence of events 304, which may include events (e.g., events E1-EN), as seen in FIG. 3. In some embodiments, training data 302 comprising the reference sequences of events, such as reference sequence of events 304, reference authentication score 306, and reference classification result 308, may be retrieved for each reference user. The plurality of reference sequences of events may be associated with reference users, such as reference users 202 of FIG. 2. Each of reference users 202 may have a corresponding reference sequence of events 204, as well as reference authentication score 206 and reference classification result 208.

At step 704, the reference sequence of events may be input into a first artificial intelligence model to obtain a training authentication score for the reference user. For example, reference sequence of events 304 may be input into first artificial intelligence model 310 to obtain authentication score 312. In some embodiments, the first artificial intelligence model may be a pre-trained model. Alternatively, some embodiments include the first artificial intelligence model being untrained (and thus, process 700 trains the model). In one or more examples, the first artificial intelligence model (e.g., first artificial intelligence model 310) may be an LLM. The first artificial intelligence model may be configured to predict a likelihood that a request submitted with the reference sequence of events would be granted or denied.

At step 706, a first loss may be computed based on the training authentication score and a reference authentication score of the plurality of reference authentication scores associated with the reference sequence of events. For example, loss 316 may be determined based on authentication score 312 and reference authentication score 306. As mentioned above, with reference to FIG. 2, each reference sequence of events 204 associated with each reference user 202 may include reference authentication scores 206. Reference authentication scores 206 may serve as ground truth for the first artificial intelligence model to learn and improve its predictive capabilities. In some cases, the reference authentication score may be used to determine a classification result. For example, reference sequence of events 304 of FIG. 3 may be input into first artificial intelligence model 310 to obtain authentication score 312, and authentication score 312 may be used to determine classification result 314.

At step 708, one or more parameters of the first artificial intelligence model may be updated based on the first loss. For example, updates 318 may be determined based on loss 316. In some embodiments, updates 318 may indicate which model parameters (e.g., weights, biases) of first artificial intelligence model 310 are to be modified and how much to modify those parameters. One or more optimization algorithms may also be used to determine updates 318 (e.g., stochastic gradient descent).

At step 710, a determination may be made as to whether the first artificial intelligence model satisfies one or more threshold training conditions. Step 710 may be performed subsequent to the parameters being updated. For example, a determination may be made as to whether first artificial intelligence model 310 produces results with an accuracy greater than or equal to a threshold accuracy (e.g., 80% or greater, 90% or greater, 95% or greater). As another example, a determination may be made as to whether first artificial intelligence model 310 has analyzed each reference sequence of events.

If, at step 710, it is determined that the first artificial intelligence model satisfies the threshold training conditions, then process 700 may proceed to step 712. At step 712, one or more parameter values of the one or more parameters of the first artificial intelligence model may be provided to a second artificial intelligence model to use as one or more initial parameter values for one or more parameters of the second artificial intelligence model during training. For example, after the threshold training conditions have been satisfied, first artificial intelligence model 310 may be considered “trained.” An example of a trained instance of first artificial intelligence model 310 corresponds to first artificial intelligence model 110 of FIG. 1. Thus, the parameter values of some or all of the parameters of first artificial intelligence model 110 may be provided to a to-be-trained version of second artificial intelligence model 112 (i.e., second artificial intelligence model 420 of FIG. 4) to be used as initial parameter values.

If, however, at step 710, it is determined that the first artificial intelligence model fails to satisfy the threshold training conditions, process 700 may return to step 702. At step 702, another reference sequence of events associated with another reference user may be selected—for example, reference sequence of events 204-M associated with reference user 202-M. After another reference sequence of events has been selected, steps 704-710 of process 700 may repeat. In some embodiments, process 700 may iterate until some or all of the threshold training conditions have been satisfied.

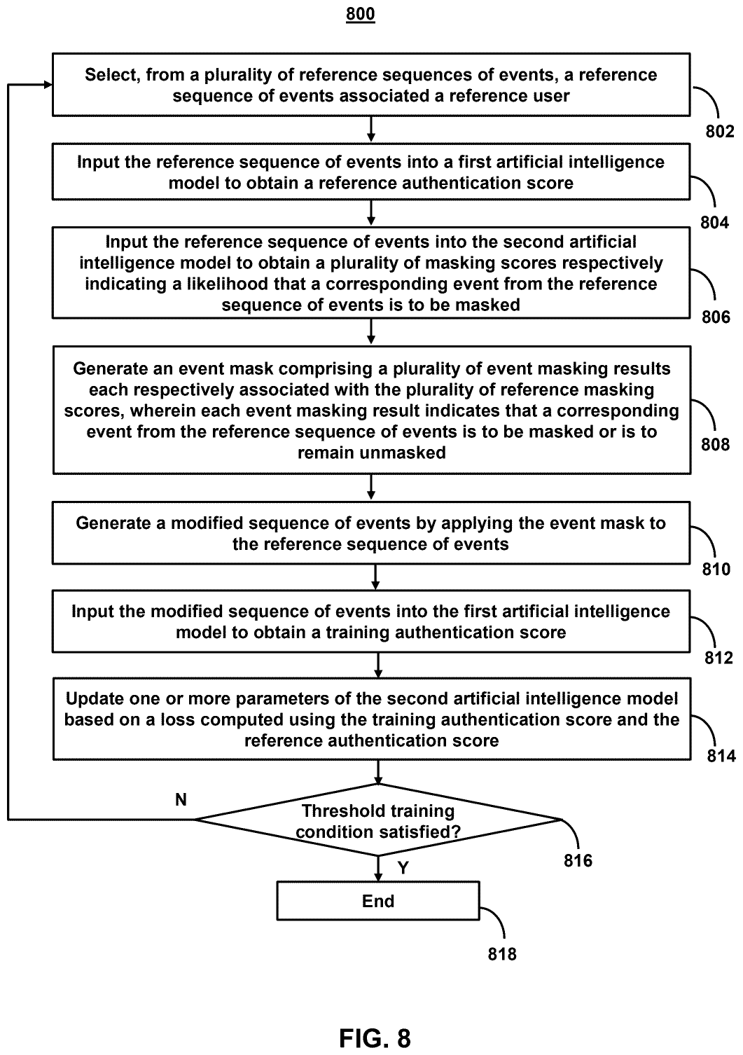

FIG. 8 illustrates a flowchart of an example process 800 for training a second artificial intelligence model to be used as an explainer model for identifying a subset of events that are most influential to the prediction made by a use-case model, in accordance with one or more embodiments. In some embodiments, the use-case model refers to first artificial intelligence model 110 and the explainer model refers to second artificial intelligence model 112. Process 800, in some embodiments, may begin at step 802.

At step 802, a reference sequence of events associated with a user may be selected from a plurality of reference sequences of events associated with a plurality of reference users. In some embodiments, training data 402 of FIG. 4 may include reference sequences of events (similar to reference sequences of events 204 of FIG. 2). From those reference sequences of events, reference sequence of events 404 may be selected. In some examples, reference sequence of events 404 may be selected randomly from those reference sequences of events included in training data 402.

At step 804, the reference sequence of events may be input into a first artificial intelligence model to obtain a reference authentication score. As an example, reference sequence of events 404 may be input into first artificial intelligence model 410 to obtain reference authentication score 412. In some embodiments, first artificial intelligence model 410 may be the same or similar to first artificial intelligence model 110 of FIG. 1. First artificial intelligence model 110 and/or 410 may be referred to as a “use-case” model. In some examples, first artificial intelligence model 110 and/or 410 may be a pre-trained model.

At step 806, the reference sequence of events may be input into the second artificial intelligence model to obtain a plurality of masking scores respectively indicating a likelihood that a corresponding event from the reference sequence of events is to be masked. For example, in addition to being input into first artificial intelligence model 410, reference sequence of events 404 may be input into second artificial intelligence model 420 to obtain masking scores 422. Masking scores 422 may be respectively associated with the events included within reference sequence of events 404 (i.e., masking score M1 corresponds to event E1, masking score M2 corresponds to event E2, and so on). In some examples, second artificial intelligence model 420 may be initialized using parameter values obtained from first artificial intelligence model 410. In some examples, reference sequence of events 404 may be input into first artificial intelligence model 410 in parallel to being input into second artificial intelligence model 420.

At step 808, an event mask comprising a plurality of event masking results each respectively associated with the plurality of reference masking scores may be generated. Each event masking result indicates that a corresponding event from the reference sequence of events is to be masked or is to remain unmasked. In some embodiments, threshold function 430 may be applied to masking scores 422 to generate event mask 432. Threshold function 430 may be configured to determine whether an event should be masked. Determining whether an event should be masked may include determining whether that event's masking score satisfies a threshold masking condition. For example, the event may be masked if the event's masking score is greater than or equal to a threshold masking score. As another example, an event may be masked if the event's masking score is one of the top-K masking scores produced by second artificial intelligence model 420.

At step 810, a modified sequence of events may be generated by applying the event mask to the reference sequence of events. Event mask 432 may include masking results indicating, for each event, whether that event is to be masked. If so, as seen in modified sequence of events 444, those events will be masked. However, events that are not to be masked may remain unchanged.

At step 812, the modified sequence of events may be input into the first artificial intelligence model to obtain a training authentication score. For example, modified sequence of events 444 may be input into first artificial intelligence model 410, which may output training authentication score 442. If second artificial intelligence model 420 was able to accurately identify events that contribute the most to the generation of reference authentication score 412 by first artificial intelligence model 410, then training authentication score 442 should be a “worse” prediction than reference authentication score 412. This would indicate that second artificial intelligence model 420 was able to identify the most important events in reference sequence of events 404.

At step 814, one or more parameters of the second artificial intelligence model may be updated based on a loss computed using the training authentication score and the reference authentication score. In some examples, loss 450 may be computed using reference authentication score 412 and training authentication score 442. Loss 450 can be computed using one or more metrics. For example, one or more regression metrics, such as root mean squared error (RMSE), mean square error (MSE), mean absolute error (MAE), etc., may be used to compute loss 450. In some examples, it may be compared with cross entropy. In some embodiments, parameters of second artificial intelligence model 420 may be updated based on loss 450. For example, parameters of second artificial intelligence model 420 may be updated by maximizing loss 450. This allows second artificial intelligence model 420 to learn to pick the most important events from a sequence of events.

At step 816, a determination may be made as to whether a threshold training condition has been satisfied. For example, a determination may be made as to whether training data 402 includes any additional reference sequences of events to be analyzed via training process 400. As another example, a determination may be made as to whether second artificial intelligence model 420 has an accuracy greater than or equal to a threshold accuracy. As yet another example, a determination may be made as to whether a certain number of iterations of training process 400 has occurred or a predetermined amount of time has elapsed. Alternative threshold training conditions may also be included.

If, at step 816, it is determined that the threshold training condition has not been satisfied, process 800 may return to step 802. At step 802, another reference sequence of events associated with another reference user may be selected, and steps 804-816 may be repeated. However, if at step 816 it is determined that the threshold training condition has been satisfied, then process 800 may proceed to step 818. At step 818, process 800 may end. Upon ending process 800, the trained version of second artificial intelligence model 420 may be stored and/or deployed for analyzing production data, as exemplified by second artificial intelligence model 112 of FIG. 1.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for updating a transformer model to identify key events.
2. The method of embodiment 1, comprising: receiving a request to authorize a user; retrieving event sequence data representing a sequence of events associated with the user based on the request; generating, using a first artificial intelligence model, a classification result for the request based on the event sequence data, wherein the classification result indicates that the request was granted or denied; determining, using a second artificial intelligence model, a subset of events from the sequence of events each having a masking score that satisfies a threshold masking condition, the masking score indicating an amount of influence an event has on classification results generated by the first artificial intelligence model; and providing, to the user, a response to the request, the response comprising the classification result and the subset of events.
3. The method of embodiment 2, wherein generating the classification result comprises: computing, using the first artificial intelligence model, an authentication score for the user based on the event sequence data; and classifying, using the first artificial intelligence model, the event sequence data into a first class or a second class based on the authentication score, wherein the classification result indicates that the event sequence data was classified into the first class or the second class.
4. The method of embodiment 3, wherein the request comprises a request to grant access to the user.
5. The method of embodiment 4, wherein classifying the event sequence data comprises: classifying the event sequence data into the first class, indicating that access to the user has been granted.
6. The method of embodiment 4, wherein classifying the event sequence data comprises: classifying the event sequence data into the second class, indicating that access to the user was denied.
7. The method of any one of embodiments 1-6, further comprising: training the first artificial intelligence model using training data comprising (a) training event sequence data comprising a plurality of reference sequences of events and (b) a plurality of reference authentication scores respectively associated with the plurality of reference sequences of events.
8. The method of claim 7, wherein the training data further comprises (c) a plurality of reference classification results respectively associated with the plurality of reference authentication scores.
9. The method of embodiment 7 or 8, wherein training the first artificial intelligence model comprises: (i) selecting, from the plurality of reference sequences of events, a reference sequence of events associated with a reference user; (ii) inputting the reference sequence of events into the first artificial intelligence model to obtain a training authentication score for the reference user; (iii) computing a first loss based on the training authentication score and a reference authentication score of the plurality of reference authentication scores associated with the reference sequence of events; and (iv) updating one or more parameters of the first artificial intelligence model to minimize the first loss.
10. The method of embodiment 9, further comprising: determining that a threshold training condition has not been satisfied; and repeating steps (i)-(iv) for another reference sequence of events of the plurality of reference sequences of events until the threshold training condition has been satisfied.
11. The method of embodiment 9, further comprising: determining that a threshold training condition has been satisfied; and providing one or more parameter values of the one or more parameters of the first artificial intelligence model to the second artificial intelligence model to use as one or more initial parameter values for one or more parameters of the second artificial intelligence model during training.
12. The method of any one of embodiments 1-11, further comprising: training the second artificial intelligence model using training event sequence data, wherein the training event sequence data comprises a plurality of reference sequences of events associated with a plurality of reference users.
13. The method of embodiment 12, wherein training the second artificial intelligence model comprises: (i) selecting, from the plurality of reference sequences of events, a reference sequence of events associated with a reference user; (ii) inputting the reference sequence of events into the first artificial intelligence model to obtain a first training authentication score; (iii) inputting the reference sequence of events into the second artificial intelligence model to obtain a plurality of training masking scores respectively indicating a likelihood that a corresponding event from the reference sequence of events is to be masked; (iv) generating a training event mask comprising a plurality of training event masking results each respectively associated with the plurality of training masking scores, wherein each training event masking result indicates that a corresponding event from the reference sequence of events is to be masked or is to remain unmasked; (v) generating a training masked sequence of events by applying the training event mask to the reference sequence of events; (vi) inputting the training masked sequence of events into the first artificial intelligence model to obtain a second training authentication score; and (vii) updating one or more parameters of the second artificial intelligence model based on a loss computed using the first training authentication score and the second training authentication score.
14. The method of embodiment 13, further comprising: determining that the second artificial intelligence model, subsequent to the one or more parameters being updated, satisfies a threshold training condition; and storing the second artificial intelligence model.
15. The method of embodiment 13, further comprising: determining that the second artificial intelligence model, subsequent to the one or more parameters being updated, fails to satisfy a threshold training condition: repeating steps (i)-(vii) using another reference sequence of training events from the plurality of reference sequences of events until the threshold training condition has been satisfied.
16. The method of any one of embodiments 13-15, wherein each of the plurality of training event masking results comprises a first value or a second value, the first value indicating that a corresponding training masking score satisfies the threshold masking condition and the second value indicating that the corresponding training masking score fails to satisfy the threshold masking condition.
17. The method of any one of embodiments 13-16, wherein the threshold masking condition being satisfied comprises determining that a corresponding masking score is greater than or equal to a threshold masking score.
18. The method of any one of embodiments 1-17, wherein generating the classification result comprises: generating, using the first artificial intelligence model, based on the event sequence data, an embedding representing the sequence of events; generating, using the first artificial intelligence model, an authentication score representing a likelihood that the request is to be granted or denied based on the embedding; and classifying, using the first artificial intelligence model, the authentication score into a first class indicating that the request is to be granted or a second class indicating that the request is to be denied.
19. The method of embodiment 18, further comprising: providing access to secure data to the user based on the classification result indicating that the event sequence data was classified into the first class.
20. The method of embodiment 18 or 19, wherein classifying the authentication score into the first class or the second class comprises: classifying the event sequence data into the first class based on a determination that the authentication score is greater than or equal to a threshold data access score.
21. The method of any one of embodiments 18-20, wherein classifying the authentication score into the first class or the second class comprises: classifying the event sequence data into the second class based on a determination that the authentication score is less than the threshold data access score.
22. The method of any one of embodiments 1-21, further comprising: training the second artificial intelligence model by initializing at least one parameter of the second artificial intelligence model with a corresponding value of the at least one parameter from the first artificial intelligence model.
23. The method of any one of embodiments 1-22, wherein the threshold masking condition being satisfied comprises: the masking score of an event being greater than or equal to a threshold masking score.
24. The method of any one of embodiments 1-23, wherein the threshold masking condition being satisfied comprises: the masking score of an event being one of a top-K masking scores a plurality of masking scores produced by the second artificial intelligence model based on the sequence of events.
25. One or more non-transitory, machine-readable media storing instructions that, when executed by one or more data processing apparatuses, cause operations comprising those of any of embodiments 1-24.
26. A system comprising one or more processors and memory storing instructions that, when executed by the processors, cause the processors to effectuate operations comprising those of any of embodiments 1-24.
27. A system comprising means for performing any of embodiments 1-24.
28. A system comprising cloud-based circuitry for performing any of embodiments 1-24.
29. A service provider comprising one or more processors programmed to perform any of embodiments 1-24.

What is claimed is:

1. A system for updating a transformer model to identify key events influencing outputs from another transformer model, the system comprising:
one or more processors programmed to:
receive a request to authorize access for a user device associated with a user;
responsive to receiving the request to authorize access, retrieve event sequence data representing a sequence of events describing interactions of the user device with a server;
input the event sequence data into a first transformer model trained to generate a classification result indicating that the request to authorize access was granted or denied; and
input the event sequence data into a second transformer model trained to identify a subset of events from the sequence of events determined to have a threshold amount of influence on the classification result generated by the first transformer model, wherein to train the second transformer model, the one or more processors being configured to:
for each training sequence of events of a plurality of training sequences of events:
input the training sequence of events into the first transformer model to obtain a first training classification result;
input the training sequence of events into the second transformer model to obtain a plurality of masking scores respectively indicating a likelihood that a corresponding event from the training sequence of events is to be masked;
generate a training event mask comprising a plurality of training event masking results respectively associated with the plurality of masking scores, wherein each training event masking result indicates that a corresponding event from the training sequence of events is to be masked or that the corresponding event is to remain unmasked;
generate a masked sequence of events by applying the training event mask to the sequence of events;
input the masked sequence of events into the first transformer model to obtain a second training classification result; and
update one or more parameters of the second transformer model based on a loss computed using the first training classification result and the second training classification result.

2. A method for updating a transformer model to identify key events, the method being implemented using one or more processors of a computing system, the method comprising:
receiving a request to authorize a user;
retrieving event sequence data representing a sequence of events associated with the user based on the request;
generating, using a first artificial intelligence model, a classification result for the request based on the event sequence data, wherein the classification result indicates that the request was granted or denied;
determining, using a second artificial intelligence model, a subset of events from the sequence of events each having a masking score that satisfies a threshold masking condition, the masking score indicating an amount of influence an event has on classification results generated by the first artificial intelligence model; and
providing, to the user, a response to the request, the response comprising the classification result and the subset of events.

3. The method of claim 2, wherein generating the classification result comprises:
computing, using the first artificial intelligence model, an authentication score for the user based on the event sequence data; and
classifying, using the first artificial intelligence model, the event sequence data into a first class or a second class based on the authentication score, wherein the classification result indicates that the event sequence data was classified into the first class or the second class.

4. The method of claim 3, wherein the request comprises a request to grant access to the user, classifying the event sequence data comprises:
classifying the event sequence data into the first class, indicating that access to the user has been granted; or
classifying the event sequence data into the second class, indicating that access to the user was denied.

5. The method of claim 2, further comprising:
training the first artificial intelligence model using training data comprising (a) training event sequence data comprising a plurality of reference sequences of events and (b) a plurality of reference authentication scores respectively associated with the plurality of reference sequences of events.

6. The method of claim 5, wherein training the first artificial intelligence model comprises:
(i) selecting, from the plurality of reference sequences of events, a reference sequence of events associated with a reference user;
(ii) inputting the reference sequence of events into the first artificial intelligence model to obtain a training authentication score for the reference user;
(iii) computing a first loss based on the training authentication score and a reference authentication score of the plurality of reference authentication scores associated with the reference sequence of events; and
(iv) updating one or more parameters of the first artificial intelligence model to minimize the first loss.

7. The method of claim 6, further comprising:
determining that a threshold training condition has not been satisfied; and
repeating steps (i)-(iv) for another reference sequence of events of the plurality of reference sequences of events until the threshold training condition has been satisfied.

8. The method of claim 6, further comprising:
determining that a threshold training condition has been satisfied; and
providing one or more parameter values of the one or more parameters of the first artificial intelligence model to the second artificial intelligence model to use as one or more initial parameter values for one or more parameters of the second artificial intelligence model during training.

9. The method of claim 2, further comprising:
training the second artificial intelligence model using training event sequence data, wherein the training event sequence data comprises a plurality of reference sequences of events associated with a plurality of reference users.

10. The method of claim 9, wherein training the second artificial intelligence model comprises:
(i) selecting, from the plurality of reference sequences of events, a reference sequence of events associated with a reference user;
(ii) inputting the reference sequence of events into the first artificial intelligence model to obtain a first training authentication score;
(iii) inputting the reference sequence of events into the second artificial intelligence model to obtain a plurality of training masking scores respectively indicating a likelihood that a corresponding event from the reference sequence of events is to be masked;
(iv) generating a training event mask comprising a plurality of training event masking results each respectively associated with the plurality of training masking scores, wherein each training event masking result indicates that a corresponding event from the reference sequence of events is to be masked or is to remain unmasked;
(v) generating a training masked sequence of events by applying the training event mask to the reference sequence of events;
(vi) inputting the training masked sequence of events into the first artificial intelligence model to obtain a second training authentication score; and
(vii) updating one or more parameters of the second artificial intelligence model based on a loss computed using the first training authentication score and the second training authentication score.

11. The method of claim 10, further comprising:
determining that the second artificial intelligence model, subsequent to the one or more parameters being updated, satisfies a threshold training condition; and
storing the second artificial intelligence model.

12. The method of claim 10, further comprising:
determining that the second artificial intelligence model, subsequent to the one or more parameters being updated, fails to satisfy a threshold training condition; and
repeating steps (i)-(vii) using another reference sequence of training events from the plurality of reference sequences of events until the threshold training condition has been satisfied.

13. The method of claim 10, wherein each of the plurality of training event masking results comprises a first value or a second value, the first value indicating that a corresponding training masking score satisfies the threshold masking condition and the second value indicating that the corresponding training masking score fails to satisfy the threshold masking condition.

14. The method of claim 10, wherein the threshold masking condition being satisfied comprises determining that a corresponding masking score is greater than or equal to a threshold masking score.

15. The method of claim 2, wherein generating the classification result comprises:
generating, using the first artificial intelligence model, based on the event sequence data, an embedding representing the sequence of events;
generating, using the first artificial intelligence model, an authentication score representing a likelihood that the request is to be granted or denied based on the embedding; and
classifying, using the first artificial intelligence model, the authentication score into a first class indicating that the request is to be granted or a second class indicating that the request is to be denied.

16. The method of claim 15, further comprising:
providing access to secure data to the user based on the classification result indicating that the event sequence data was classified into the first class.

17. The method of claim 15, wherein classifying the authentication score into the first class or the second class comprises:
classifying the event sequence data into the first class based on a determination that the authentication score is greater than or equal to a threshold data access score; or
classifying the event sequence data into the second class based on a determination that the authentication score is less than the threshold data access score.

18. The method of claim 2, further comprising:
training the second artificial intelligence model by initializing at least one parameter of the second artificial intelligence model with a corresponding value of the at least one parameter from the first artificial intelligence model.

19. The method of claim 2, wherein the threshold masking condition being satisfied comprises:
the masking score of an event being greater than or equal to a threshold masking score; or
the masking score of an event being one of a top-K masking scores a plurality of masking scores produced by the second artificial intelligence model based on the sequence of events.

20. One or more non-transitory, computer-readable media storing computer program instructions that, when executed by one or more processors of a computing system, effectuate operations comprising:
receiving a request to authorize a user;
retrieving event sequence data representing a sequence of events associated with the user based on the request;
generating, using a first artificial intelligence model, a classification result for the request based on the event sequence data, wherein the classification result indicates that the request was granted or denied;
determining, using a second artificial intelligence model, a subset of events from the sequence of events each having a masking score that satisfies a threshold masking condition, the masking score indicating an amount of influence an event has on classification results generated by the first artificial intelligence model; and
providing, to the user, a response to the request, the response comprising the classification result and the subset of events.
